(19) United States
(12) Patent Application Publication
(10) Pub. No.: US 2007/0213934 A1
(43) Pub. Date: Sep. 13, 2007

(54) Weather box

(75) Inventor: Gary Reed, Newmarket (CA)

Correspondence Address: MILLEN, WHITE, ZELANO & BRANIGAN, P.C., 2200 CLARENDON BLVD., SUITE 1400, ARLINGTON, VA, 22201, US

(73) Assignee: THERMOR LTD.

(21) Appl. No.: 11/712,394

(22) Filed: Mar. 1, 2007

Related U.S. Application Data
(60) Provisional application No. 60/780,371, filed on Mar. 9, 2006.

(51) Int. Cl. G06F 19/00

(52) U.S. Cl. 702/2; 702/1; 702/3; 702/189; 340/870.01; 340/870.07

(57) ABSTRACT

An apparatus includes an outdoor device and an indoor device. The outdoor device includes an outdoor thermometer, an anemometer, a rain gauge, and a transmitter coupled to the outdoor thermometer, the anemometer and the rain gauge. The indoor device includes a receiver, a processor coupled to the receiver, and a television modulator coupled to the processor. Outdoor weather data includes an outdoor temperature provided by the outdoor thermometer, a wind speed provided by the anemometer and a rain fall measurement provided by the rain gauge. The transmitter is operable to send the outdoor weather data to the receiver. The receiver provides the outdoor weather data to the processor. The processor is operable to provide screen image data, the screen image data being based on and including the outdoor weather data. The television modulator is operable to provide a television signal having the screen image data carried therein. The television signal is compatible with either an auxiliary input to a television or a tuner input to a television tuned to a predetermined channel.

This application claims the priority benefit of the Mar. 9, 2006 filing date of U.S. Application 60/780,371.

### BACKGROUND OF THE INVENTION

### Description Of Related Art

Small weather stations are known. For example, some include an outdoor unit with weather sensors and an indoor unit with indicators specifying the data sensed by the weather sensors. It is known to use indoor indicators based on LCD (liquid crystal display) technology to display weather data. It is known to use an indoor unit that is coupled to personal computers.

What is needed is an indoor unit that provides weather data formatted in a form that can be input into a television as if it were a DVD player or a VCR player for display as if it were an alternative channel or video device (e.g., DVD or VCR).

### SUMMARY OF THE INVENTION

An embodiment of the invention is an apparatus that includes an outdoor device and an indoor device. The outdoor device includes an outdoor thermometer, an anemometer, a rain gauge, and a transmitter coupled to the outdoor thermometer, the anemometer and the rain gauge. The indoor device includes a receiver, a processor coupled to the receiver, and a television modulator coupled to the processor. Outdoor weather data includes an outdoor temperature provided by the outdoor thermometer, a wind speed provided by the anemometer and a rain fall measurement provided by the rain gauge. The transmitter is operable to send the outdoor weather data to the receiver. The receiver provides the outdoor weather data to the processor. The processor is operable to provide screen image data, the screen image data being based on and including the outdoor weather data. The television modulator is operable to provide a television signal having the screen image data carried therein. The television signal is compatible with either an auxiliary input to a television or a tuner input to a television tuned to a predetermined channel.

Another embodiment of the invention is a method that includes transmitting weather data, processing the weather data and providing a television signal. The transmitted weather data is obtained from outdoor sensors and transmitted to an indoor receiver. The weather data received by the indoor receiver is processed to provide screen image data based on and including the weather data. The providing of the television signal provides a signal having the screen image data carried therein.

### BRIEF DESCRIPTION OF DRAWINGS

The invention will be described in detail in the following description of preferred embodiments with reference to the following figure.

FIG. 1 is a function block illustrating an indoor device 200 and an outdoor device 100.

### DETAILED DESCRIPTION OF PREFERRED EMBODIMENTS

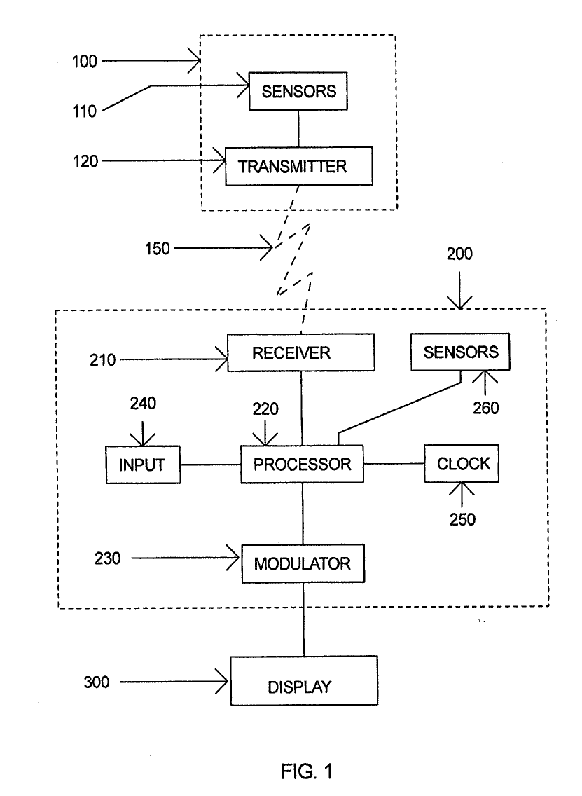

An embodiment of a weather box includes an outdoor device 100 and an indoor device 200. See FIG. 1. The indoor device is able to be coupled to a television 300, and in such configuration, the indoor device is operable to cause weather data to be displayed on the television. The outdoor device includes an outdoor thermometer, an anemometer (collectively, sensors 110), and a transmitter 120 coupled to the outdoor thermometer and the anemometer. The indoor device includes a receiver 210 operable to receive signals 150 from the transmitter 120, a processor 220 coupled to the receiver, and a television modulator 230 coupled to the processor. Outdoor weather data includes an outdoor temperature provided by the outdoor thermometer and a wind speed provided by the anemometer. The transmitter 120 is operable to send the outdoor weather data to the receiver 210, and the receiver provides the outdoor weather data to the processor 220. The processor is operable to provide screen image data to a television. The screen image data is based on and includes the outdoor weather data. The television modulator 230 is operable to provide a television signal having the screen image data carried therein. The television signal is compatible with an auxiliary input to a television or a tuner input to a television tuned to a predetermined channel or any other input (e.g., S-video, RGB, etc.) to a television.

As used herein, television is to be interpreted to mean consumer television receivers whether such receivers process signals received over the air from broadcast stations or satellites, via cable or other transmission means, or receive signals from DVD or VCR playback devices. Such televisions are widely distributed in households and businesses in the U.S., Canada and around the world. Often a single household will own multiple televisions prominently disposed on tables or countertops in the home. Embodiments of the invention have the advantage over other weather stations that the present embodiments do not require separate displays. Instead, a modulator is provided to produce signals to carry weather data as screen image data into an already existing television for display. Embodiments of the invention can be realized in a small box, perhaps the size of a paperback book, that is unobtrusively disposed on the side of or behind an existing television, thus saving valuable countertop space.

Most contemporary televisions provide an auxiliary input through which a DVD player (as an example) may be coupled and so that, when the television is operated to select the auxiliary input for video display, the contents of the DVD is displayed. The indoor device described above may be coupled to such an auxiliary input.

Often, a VCR is coupled between the antenna input of a television and an antenna. When the VCR is Off or otherwise in a TV mode, signals from the antenna pass through the VCR to the antenna input of the television. However, typically, when the VCR is turned On, the VCR substitutes its internal tuner or video tape reader for the signals from the antenna. In such a circumstance, the VCR modulates these signals onto a carrier frequency tuned to, for example, either channel 3 or channel 4.

The indoor device described above, as an alternative to the device that couples to the auxiliary input, may be coupled to the antenna input of a television, the antenna input of a VCR, or an input to a video multiplexer that is coupled to the antenna input of a television or the antenna input of a VCR.

In a first variant of the embodiment, the outdoor device further includes a wind direction sensor to provide a wind direction measurement to the transmitter and a rain gauge to provide a rain fall measurement to the transmitter. The outdoor weather data is defined to further include the wind direction measurement and the rain fall measurement.

In a second variant of the embodiment, the outdoor device further includes an ultraviolet intensity monitor to provide an ultraviolet intensity measurement to the transmitter. The outdoor weather data is defined to further include the ultraviolet intensity measurement.

In a third variant of the embodiment, the outdoor device further includes an outdoor hygrometer to provide an outdoor humidity measurement to the transmitter. The outdoor weather data is defined to further include the outdoor humidity measurement.

In a fourth variant of the embodiment, the indoor device further includes an indoor thermometer to provide an indoor temperature to the processor and a clock for providing a time and a date to the processor. The screen image data is further based on and further includes the indoor temperature, the time, and the date.

In a fifth variant of the embodiment, the indoor device further includes an indoor hygrometer to provide an indoor humidity measurement to the processor. The screen image data is further based on and further includes the indoor humidity measurement.

In a sixth variant of the embodiment, the indoor device further includes a barometer to provide a barometric pressure measurement to the processor. The screen image data is further based on and further includes the barometric pressure measurement.

In a seventh variant of the embodiment, the indoor device further includes input circuitry coupled to the processor. The input circuitry includes a reset actuator. The transmitter is operable to send periodic updates of the outdoor weather data to the receiver at predetermined intervals (e.g., every couple of minutes or in a binary example, every 128 seconds). A first parameter of outdoor weather data includes either the outdoor temperature or the wind speed. The processor includes a first program module operable to store a maximum value of the first parameter and a minimum value of the first parameter. The first program module further updates the maximum value of the first parameter and the minimum value of the first parameter each time a periodic update of the outdoor weather data is received by the receiver. The first program module further resets the maximum value of the first parameter to a predetermined maximum default value for the first parameter when the reset actuator is actuated, and resets the minimum value of the first parameter to a predetermined minimum default value for the first parameter when the reset actuator is actuated. The screen image data is further based on and further includes the maximum value of the first parameter and the minimum value of the first parameter. The first program module may be one program module or a set of related program module that collectively perform the described functions.

In a first example of the seventh variant of the embodiment, a second parameter of outdoor weather data includes the other of either the outdoor temperature or the wind speed. The processor includes a second program module to store a maximum value of the second parameter and a minimum value of the second parameter. The second program module further updates the maximum value of the second parameter and the minimum value of the second parameter each time a periodic update of the outdoor weather data is received by the receiver. The second program module resets the maximum value of the second parameter to a predetermined maximum default value for the second parameter when the reset actuator is actuated, and resets the minimum value of the second parameter to a predetermined minimum default value for the second parameter when the reset actuator is actuated. The screen image data is further based on and further includes the maximum value of the second parameter and the minimum value of the second parameter. The first and second program modules may be separate program modules or may be a combined program module, in whole or in part (i.e., having common sub modules). The use of the terms “first program module” and “second program module” should not be construed to require a meaning of separate program modules.

In an alternative of the first example of the seventh variant of the embodiment, the outdoor device further includes a rain gauge to provide a rain fall measurement to the transmitter. A second parameter of outdoor weather data includes the rain fall measurement. The processor includes a program module to store a maximum value of the second parameter and a minimum value of the second parameter. The program module updates the maximum value of the second parameter and the minimum value of the second parameter each time a periodic update of the outdoor weather data is received by the receiver. The program module resets the maximum value of the second parameter to a predetermined maximum default value for the second parameter when the reset actuator is actuated, and resets the minimum value of the second parameter to a predetermined minimum default value for the second parameter when the reset actuator is actuated. The screen image data is further based on and further includes the maximum value of the second parameter and the minimum value of the second parameter. The program module, together with the first program module may be separate program modules or may be a combined program module, in whole or in part (e.g., having common sub modules). The use of the terms “first program module” and “program module” should not be construed to require a meaning of separate program modules.

In a second example of the seventh variant of the embodiment, the outdoor device further includes an ultraviolet intensity monitor to provide an ultraviolet intensity measurement to the transmitter. The outdoor weather data is defined to further include the ultraviolet intensity measurement. A second parameter of outdoor weather data includes the ultraviolet intensity measurement. The processor includes a second program module to store a maximum value of the second parameter and a minimum value of the second parameter. The second program module updates the maximum value of the second parameter and the minimum value of the second parameter each time a periodic update of the outdoor weather data is received by the receiver. The second program module resets the maximum value of the second parameter to a predetermined maximum default value for the second parameter when the reset actuator is actuated, and resets the minimum value of the second parameter to a predetermined minimum default value for the second parameter when the reset actuator is actuated. The screen image data is further based on and further includes the maximum value of the second parameter and the minimum value of the second parameter. The first and second program modules may be separate program modules or may be a combined program module, in whole or in part (i.e., having common sub modules). The use of the terms “first program module” and “second program module” should not be construed to require a meaning of separate program modules.

In a third example of the seventh variant of the embodiment, the outdoor device further includes an outdoor hygrometer to provide an outdoor humidity measurement to the transmitter. The outdoor weather data is defined to further include the outdoor humidity measurement. A second parameter of outdoor weather data includes the outdoor humidity measurement. The processor includes a second program module to store a maximum value of the second parameter and a minimum value of the second parameter. The second program module updates the maximum value of the second parameter and the minimum value of the second parameter each time a periodic update of the outdoor weather data is received by the receiver. The second program module resets the maximum value of the second parameter to a predetermined maximum default value for the second parameter when the reset actuator is actuated, and resets the minimum value of the second parameter to a predetermined minimum default value for the second parameter when the reset actuator is actuated. The screen image data is further based on and further includes the maximum value of the second parameter and the minimum value of the second parameter. The first and second program modules may be separate program modules or may be a combined program module, in whole or in part (i.e., having common sub modules). The use of the terms “first program module” and “second program module” should not be construed to require a meaning of separate program modules.

In an eighth variant of the embodiment, the indoor device further includes input circuitry to coupled to the processor and an indoor thermometer to provide an indoor temperature to the processor. The input circuitry includes a reset actuator. A first parameter includes the indoor temperature. The processor includes a program module to store a maximum value of the first parameter and a minimum value of the first parameter. The program module updates the maximum value of the first parameter and the minimum value of the first parameter at periodic intervals, resets the maximum value of the first parameter to a predetermined maximum default value for the first parameter when the reset actuator is actuated, and resets the minimum value of the first parameter to a predetermined minimum default value for the first parameter when the reset actuator is actuated. The screen image data is further based on and further includes the maximum value of the first parameter and the minimum value of the first parameter.

In a ninth variant of the embodiment, the indoor device further includes input circuitry to coupled to the processor and an indoor hygrometer to provide an indoor humidity measurement to the processor. The input circuitry includes a reset actuator. A first parameter includes the indoor humidity measurement. The processor includes a program module to store a maximum value of the first parameter and a minimum value of the first parameter. The program module updates the maximum value of the first parameter and the minimum value of the first parameter at periodic intervals, resets the maximum value of the first parameter to a predetermined maximum default value for the first parameter when the reset actuator is actuated, and resets the minimum value of the first parameter to a predetermined minimum default value for the first parameter when the reset actuator is actuated. The screen image data is further based on and further includes the maximum value of the first parameter and the minimum value of the first parameter.

In a tenth variant of the embodiment, the indoor device further includes input circuitry to coupled to the processor and a barometer to provide a barometric pressure measurement to the processor. The input circuitry includes a reset actuator. A first parameter includes the barometric pressure measurement. The processor includes a program module to store a maximum value of the first parameter and a minimum value of the first parameter. The program module updates the maximum value of the first parameter and the minimum value of the first parameter at periodic intervals, resets the maximum value of the first parameter to a predetermined maximum default value for the first parameter when the reset actuator is actuated, and resets the minimum value of the first parameter to a predetermined minimum default value for the first parameter when the reset actuator is actuated. The screen image data is further based on and further includes the maximum value of the first parameter and the minimum value of the first parameter.

In an eleventh variant of the embodiment, the indoor device further includes input circuitry to coupled to the processor. The input circuitry includes a reset actuator. The outdoor device further includes an ultraviolet intensity monitor to provide an ultraviolet intensity measurement to the transmitter. The outdoor weather data is defined to further include the ultraviolet intensity measurement. The transmitter is operable to send periodic updates of the outdoor weather data to the receiver at predetermined intervals. A first parameter of outdoor weather data includes the ultraviolet intensity measurement. The processor includes a program module to store a maximum value of the first parameter and a minimum value of the first parameter. The program module updates the maximum value of the first parameter and the minimum value of the first parameter each time a periodic update of the outdoor weather data is received by the receiver. The program module resets the maximum value of the first parameter to a predetermined maximum default value for the first parameter when the reset actuator is actuated, and resets the minimum value of the first parameter to a predetermined minimum default value for the first parameter when the reset actuator is actuated. The screen image data is further based on and further includes the maximum value of the first parameter and the minimum value of the first parameter.

In a twelfth variant of the embodiment, the indoor device further includes input circuitry to coupled to the processor. The input circuitry includes a reset actuator. The outdoor device further includes an outdoor hygrometer to provide an outdoor humidity measurement to the transmitter. The outdoor weather data is defined to further include the outdoor humidity measurement. The transmitter is operable to send periodic updates of the outdoor weather data to the receiver at predetermined intervals. A first parameter of outdoor weather data includes the outdoor humidity measurement. The processor includes a program module to store a maximum value of the first parameter and a minimum value of the first parameter. The program module updates the maximum value of the first parameter and the minimum value of the first parameter each time a periodic update of the outdoor weather data is received by the receiver, resets the maximum value of the first parameter to a predetermined maximum default value for the first parameter when the reset actuator is actuated, and resets the minimum value of the first parameter to a predetermined minimum default value for the first parameter when the reset actuator is actuated. The screen image data is further based on and further includes the maximum value of the first parameter and the minimum value of the first parameter.

In a thirteenth variant of the embodiment, the processor is operable to compute a wind chill value from the outdoor temperature and the wind speed. The screen image data is further based on and further includes the wind chill value.

In a fourteenth variant of the embodiment, the indoor device further includes input circuitry to coupled to the processor. The input circuitry includes a reset actuator. A first parameter includes the wind chill value. The processor includes a program module to store a maximum value of the first parameter and a minimum value of the first parameter. The program module updates the maximum value of the first parameter and the minimum value of the first parameter at periodic intervals, resets the maximum value of the first parameter to a predetermined maximum default value for the first parameter when the reset actuator is actuated, and resets the minimum value of the first parameter to a predetermined minimum default value for the first parameter when the reset actuator is actuated. The screen image data is further based on and further includes the maximum value of the first parameter and the minimum value of the first parameter.

In a fifteenth variant of the embodiment, the outdoor device further includes an outdoor hygrometer to provide an outdoor humidity measurement to the transmitter. The outdoor weather data is defined to further include the outdoor humidity measurement. The processor is operable to compute a dew point from the outdoor temperature and the outdoor humidity measurement. The screen image data is further based on and further includes the dew point.

In an example of the thirteenth variant of the embodiment, the indoor device further includes input circuitry to coupled to the processor. The input circuitry includes a reset actuator. A first parameter includes the dew point. The processor includes a program module to store a maximum value of the first parameter and a minimum value of the first parameter. The program module updates the maximum value of the first parameter and the minimum value of the first parameter at periodic intervals, resets the maximum value of the first parameter to a predetermined maximum default value for the first parameter when the reset actuator is actuated, and resets the minimum value of the first parameter to a predetermined minimum default value for the first parameter when the reset actuator is actuated. The screen image data is further based on and further includes the maximum value of the first parameter and the minimum value of the first parameter.

In a sixteenth variant of the embodiment, the indoor device further includes input circuitry and an alarm coupled to the processor. The input circuitry includes means for setting a threshold. The processor includes a program module to sound the alarm when the outdoor temperature is one of above the threshold and below the threshold. The means for setting a threshold may include any convenient means such as a display of the current threshold within the image data and an up and down actuator coupled to the processor to be used for adjusting the threshold up and down, respectfully. A key pad coupled to the processor could be used. A rotary or linear encoder of any type coupled to the processor could be used if the needed circuitry were included in the encoder to permit coupling to the processor.

In a seventeenth variant of the embodiment, the processor is operable to compute at least one of a sunset and a sunrise based on the date. The screen image data is further based on and further includes at least one of the sunset and the sunrise.

In an eighteenth variant of the embodiment, the processor is operable to compute a moon phase based on the date. The screen image data is further based on and further includes the moon phase.

In a method embodiment of the invention, the method includes transmitting weather data, processing the weather data and providing a television signal. The transmitted weather data is obtained from outdoor sensors and transmitted to an indoor receiver. The weather data received by the indoor receiver is processed to provide screen image data based on and including the weather data. The providing of the television signal provides a signal having the screen image data carried therein.

In a variant of the method embodiment, the television signal is compatible with either an auxiliary input to a television or a tuner input to a television tuned to a predetermined channel.

In a second variant of the method embodiment, the method further includes receiving and storing a threshold setting from input circuitry provided in an indoor unit. The processing further compares a parameter of the weather data to the threshold setting. An the method further includes sounding an alarm when the parameter is either greater than or less than, but not both, the threshold setting.

In a second method embodiment of the invention, the method includes periodically receiving radio linked updates of outdoor weather data at a processor at predetermined intervals. The method further includes storing a maximum value of a first parameter of the outdoor weather data and a minimum value of the first parameter. The method further includes updating the maximum value of the first parameter and the minimum value of the first parameter each time a periodic update of the outdoor weather data is received at the processor. The method further includes resetting the maximum value of the first parameter to a predetermined maximum default value for the first parameter when an indoor reset actuator is actuated, and resetting the minimum value of the first parameter to a predetermined minimum default value for the first parameter when the indoor reset actuator is actuated.

Having described preferred embodiments of a novel weather box (which are intended to be illustrative and not limiting), it is noted that modifications and variations can be made by persons skilled in the art in light of the above teachings. It is therefore to be understood that changes may be made in the particular embodiments of the invention disclosed which are within the scope of the invention as defined by the appended claims.

Having thus described the invention with the details and particularity required by the patent laws, what is claimed and desired protected by Letters Patent is set forth in the appended claims.

What is claimed is:

1. An apparatus comprising an outdoor device and an indoor device, wherein:
the outdoor device includes an outdoor thermometer, an anemometer, and a transmitter coupled to the outdoor thermometer and the anemometer;
the indoor device includes a receiver, a processor coupled to the receiver and a television modulator coupled to the processor;
outdoor weather data includes an outdoor temperature provided by the outdoor thermometer and a wind speed provided by the anemometer;
the transmitter is operable to send the outdoor weather data to the receiver;
the receiver provides the outdoor weather data to the processor;
the processor is operable to provide screen image data, the screen image data being based on and including the outdoor weather data; and
the television modulator is operable to provide a television signal having the screen image data carried therein, the television signal being compatible with one of an auxiliary input to a television and a tuner input to a television tuned to a predetermined channel.

2. An apparatus according to claim 1, wherein:
the outdoor device further includes a wind direction sensor to provide a wind direction measurement to the transmitter and a rain gauge to provide a rain fall measurement to the transmitter; and
the outdoor weather data being defined to further include the wind direction measurement and the rain fall measurement.

3. An apparatus according to claim 1, wherein the outdoor device further includes an ultraviolet intensity monitor to provide an ultraviolet intensity measurement to the transmitter, the outdoor weather data being defined to further include the ultraviolet intensity measurement.

4. An apparatus according to claim 1, wherein the outdoor device further includes an outdoor hygrometer to provide an outdoor humidity measurement to the transmitter, the outdoor weather data being defined to further include the outdoor humidity measurement.

5. An apparatus according to claim 1, wherein:
the indoor device further includes an indoor thermometer to provide an indoor temperature to the processor and a clock for providing a time and a date; and
the screen image data is further based on and further includes the indoor temperature, the time and the date.

6. An apparatus according to claim 1, wherein the indoor device further includes an indoor hygrometer to provide an indoor humidity measurement to the processor, the screen image data being further based on and further including the indoor humidity measurement.

7. An apparatus according to claim 1, wherein the indoor device further includes a barometer to provide a barometric pressure measurement to the processor, the screen image data being further based on and further including the barometric pressure measurement.

8. An apparatus according to claim 1, wherein:
the indoor device further includes input circuitry coupled to the processor, the input circuitry including a reset actuator;
the transmitter is operable to send periodic updates of the outdoor weather data to the receiver at predetermined intervals;
a first parameter of outdoor weather data includes one of the outdoor temperature and the wind speed;
the processor includes a first program module operable to store a maximum value of the first parameter and a minimum value of the first parameter, to update the maximum value of the first parameter and the minimum value of the first parameter each time a periodic update of the outdoor weather data is received by the receiver, to reset the maximum value of the first parameter to a predetermined maximum default value for the first parameter when the reset actuator is actuated, and to reset the minimum value of the first parameter to a predetermined minimum default value for the first parameter when the reset actuator is actuated; and
the screen image data is further based on and further includes the maximum value of the first parameter and the minimum value of the first parameter.

9. An apparatus according to claim 8, wherein
a second parameter of outdoor weather data includes another of the outdoor temperature and the wind speed;
the processor includes a second program module operable to store a maximum value of the second parameter and a minimum value of the second parameter, to update the maximum value of the second parameter and the minimum value of the second parameter each time a periodic update of the outdoor weather data is received by the receiver, to reset the maximum value of the second parameter to a predetermined maximum default value for the second parameter when the reset actuator is actuated, and to reset the minimum value of the second parameter to a predetermined minimum default value for the second parameter when the reset actuator is actuated; and
the screen image data is further based on and further includes the maximum value of the second parameter and the minimum value of the second parameter.

10. An apparatus according to claim 8, wherein:
the outdoor device further includes a rain gauge to provide a rain fall measurement to the transmitter, the outdoor weather data being defined to further include the rain fall measurement;
a second parameter of outdoor weather data includes the rain fall measurement;
the processor includes a program module operable to store a maximum value of the second parameter and a minimum value of the second parameter, to update the maximum value of the second parameter and the minimum value of the second parameter each time a periodic update of the outdoor weather data is received by the receiver, to reset the maximum value of the second parameter to a predetermined maximum default value for the second parameter when the reset actuator is actuated, and to reset the minimum value of the second parameter to a predetermined minimum default value for the second parameter when the reset actuator is actuated; and
the screen image data is further based on and further includes the maximum value of the second parameter and the minimum value of the second parameter.

11. An apparatus according to claim 8, wherein:
the outdoor device further includes an ultraviolet intensity monitor to provide an ultraviolet intensity measurement to the transmitter, the outdoor weather data being defined to further include the ultraviolet intensity measurement;
a second parameter of outdoor weather data includes the ultraviolet intensity measurement;
the processor includes a second program module operable to store a maximum value of the second parameter and a minimum value of the second parameter, to update the maximum value of the second parameter and the minimum value of the second parameter each time a periodic update of the outdoor weather data is received by the receiver, to reset the maximum value of the second parameter to a predetermined maximum default value for the second parameter when the reset actuator is actuated, and to reset the minimum value of the second parameter to a predetermined minimum default value for the second parameter when the reset actuator is actuated; and
the screen image data is further based on and further includes the maximum value of the second parameter and the minimum value of the second parameter.

12. An apparatus according to claim 8, wherein:
the outdoor device further includes an outdoor hygrometer to provide an outdoor humidity measurement to the transmitter, the outdoor weather data being defined to further include the outdoor humidity measurement;
a second parameter of outdoor weather data includes the outdoor humidity measurement;
the processor includes a program module operable to store a maximum value of the second parameter and a minimum value of the second parameter, to update the maximum value of the second parameter and the minimum value of the second parameter each time a periodic update of the outdoor weather data is received by the receiver, to reset the maximum value of the second parameter to a predetermined maximum default value for the second parameter when the reset actuator is actuated, and to reset the minimum value of the second parameter to a predetermined minimum default value for the second parameter when the reset actuator is actuated; and
the screen image data is further based on and further includes the maximum value of the second parameter and the minimum value of the second parameter.

13. An apparatus according to claim 1, wherein:
the indoor device further includes input circuitry to coupled to the processor and an indoor thermometer to provide an indoor temperature to the processor, the input circuitry including a reset actuator;
a first parameter includes the indoor temperature;
the processor includes a program module operable to store a maximum value of the first parameter and a minimum value of the first parameter, to update the maximum value of the first parameter and the minimum value of the first parameter at periodic intervals, to reset the maximum value of the first parameter to a predetermined maximum default value for the first parameter when the reset actuator is actuated, and to reset the minimum value of the first parameter to a predetermined minimum default value for the first parameter when the reset actuator is actuated; and
the screen image data is further based on and further includes the maximum value of the first parameter and the minimum value of the first parameter.

14. An apparatus according to claim 1, wherein:
the indoor device further includes input circuitry to coupled to the processor and an indoor hygrometer to provide an indoor humidity measurement to the processor, the input circuitry including a reset actuator;
a first parameter includes the indoor humidity measurement;
the processor includes a program module operable to store a maximum value of the first parameter and a minimum value of the first parameter, to update the maximum value of the first parameter and the minimum value of the first parameter at periodic intervals, to reset the maximum value of the first parameter to a predetermined maximum default value for the first parameter when the reset actuator is actuated, and to reset the minimum value of the first parameter to a predetermined minimum default value for the first parameter when the reset actuator is actuated; and
the screen image data is further based on and further includes the maximum value of the first parameter and the minimum value of the first parameter.

15. An apparatus according to claim 1, wherein:
the indoor device further includes input circuitry to coupled to the processor and a barometer to provide a barometric pressure measurement to the processor, the input circuitry including a reset actuator;
a first parameter includes the barometric pressure measurement;
the processor includes a program module operable to store a maximum value of the first parameter and a minimum value of the first parameter, to update the maximum value of the first parameter and the minimum value of the first parameter at periodic intervals, to reset the maximum value of the first parameter to a predetermined maximum default value for the first parameter when the reset actuator is actuated, and to reset the minimum value of the first parameter to a predetermined minimum default value for the first parameter when the reset actuator is actuated; and
the screen image data is further based on and further includes the maximum value of the first parameter and the minimum value of the first parameter.

16. An apparatus according to claim 1, wherein:
the indoor device further includes input circuitry to coupled to the processor, the input circuitry including a reset actuator;
the outdoor device further includes an ultraviolet intensity monitor to provide an ultraviolet intensity measurement to the transmitter, the outdoor weather data being defined to further include the ultraviolet intensity measurement;
the transmitter is operable to send periodic updates of the outdoor weather data to the receiver at predetermined intervals;
a first parameter of outdoor weather data includes the ultraviolet intensity measurement;
the processor includes a program module operable to store a maximum value of the first parameter and a minimum value of the first parameter, to update the maximum value of the first parameter and the minimum value of the first parameter each time a periodic update of the outdoor weather data is received by the receiver, to reset the maximum value of the first parameter to a predetermined maximum default value for the first parameter when the reset actuator is actuated, and to reset the minimum value of the first parameter to a predetermined minimum default value for the first parameter when the reset actuator is actuated; and
the screen image data is further based on and further includes the maximum value of the first parameter and the minimum value of the first parameter.

17. An apparatus according to claim 1, wherein:
the indoor device further includes input circuitry to coupled to the processor, the input circuitry including a reset actuator;
the outdoor device further includes an outdoor hygrometer to provide an outdoor humidity measurement to the transmitter, the outdoor weather data being defined to further include the outdoor humidity measurement;
the transmitter is operable to send periodic updates of the outdoor weather data to the receiver at predetermined intervals;
a first parameter of outdoor weather data includes the outdoor humidity measurement;
the processor includes a program module operable to store a maximum value of the first parameter and a minimum value of the first parameter, to update the maximum value of the first parameter and the minimum value of the first parameter each time a periodic update of the outdoor weather data is received by the receiver, to reset the maximum value of the first parameter to a predetermined maximum default value for the first parameter when the reset actuator is actuated, and to reset the minimum value of the first parameter to a predetermined minimum default value for the first parameter when the reset actuator is actuated; and
the screen image data is further based on and further includes the maximum value of the first parameter and the minimum value of the first parameter.

18. An apparatus according to claim 1, wherein:
the processor is operable to compute a wind chill value from the outdoor temperature and the wind speed; and
the screen image data is further based on and further includes the wind chill value.

19. An apparatus according to claim 18, wherein:
the indoor device further includes input circuitry to coupled to the processor, the input circuitry including a reset actuator;
a first parameter includes the wind chill value;
the processor includes a program module operable to store a maximum value of the first parameter and a minimum value of the first parameter, to update the maximum value of the first parameter and the minimum value of the first parameter at periodic intervals, to reset the maximum value of the first parameter to a predetermined maximum default value for the first parameter when the reset actuator is actuated, and to reset the minimum value of the first parameter to a predetermined minimum default value for the first parameter when the reset actuator is actuated; and
the screen image data is further based on and further includes the maximum value of the first parameter and the minimum value of the first parameter.

20. An apparatus according to claim 1, wherein:
the outdoor device further includes an outdoor hygrometer to provide an outdoor humidity measurement to the transmitter, the outdoor weather data being defined to further include the outdoor humidity measurement;
the processor is operable to compute a dew point from the outdoor temperature and the outdoor humidity measurement; and
the screen image data is further based on and further includes the dew point.

21. An apparatus according to claim 18, wherein:
the indoor device further includes input circuitry to coupled to the processor, the input circuitry including a reset actuator;
a first parameter includes the dew point;
the processor includes a program module operable to store a maximum value of the first parameter and a minimum value of the first parameter, to update the maximum value of the first parameter and the minimum value of the first parameter at periodic intervals, to reset the maximum value of the first parameter to a predetermined maximum default value for the first parameter when the reset actuator is actuated, and to reset the minimum value of the first parameter to a predetermined minimum default value for the first parameter when the reset actuator is actuated; and
the screen image data is further based on and further includes the maximum value of the first parameter and the minimum value of the first parameter.

22. An apparatus according to claim 1, wherein:
the indoor device further includes input circuitry and an alarm coupled to the processor, the input circuitry including means for setting a threshold; and
the processor includes a program module operable to sound the alarm when the outdoor temperature is one of above the threshold and below the threshold.

23. An apparatus according to claim 1, wherein:
the processor is operable to compute at least one of a sunset and a sunrise based on the date; and
the screen image data is further based on and further includes at least one of the sunset and the sunrise.

24. An apparatus according to claim 1, wherein:
the processor is operable to compute a moon phase based on the date; and
the screen image data is further based on and further includes the moon phase.

25. A method comprising:
transmitting weather data obtained from outdoor sensors to an indoor receiver;
processing the weather data received by the indoor receiver to provide screen image data, the screen image data being based on and including the weather data; and
providing a television signal having the screen image data carried therein.

26. A method according to claim 25, wherein the television signal is compatible with one of an auxiliary input to a television and a tuner input to a television tuned to a predetermined channel.

27. A method according to claim 25, wherein:
the method further comprises receiving and storing a threshold setting;
the processing further compares a parameter of the weather data to the threshold setting; and
the method further comprises sounding an alarm when the parameter is one of greater and less than the threshold setting.

28. A method comprising:
periodically receiving radio linked updates of outdoor weather data at a processor at predetermined intervals;
storing a maximum value of a first parameter of the outdoor weather data and a minimum value of the first parameter;
updating the maximum value of the first parameter and the minimum value of the first parameter each time a periodic update of the outdoor weather data is received at the processor;
resetting the maximum value of the first parameter to a predetermined maximum default value for the first parameter when an indoor reset actuator is actuated; and
resetting the minimum value of the first parameter to a predetermined minimum default value for the first parameter when the indoor reset actuator is actuated.
